(19) United States
(12) Patent Application Publication
(10) Pub. No.: US 2015/0160731 A1
(43) Pub. Date: Jun. 11, 2015

(54) METHOD OF RECOGNIZING GESTURE THROUGH ELECTRONIC DEVICE, ELECTRONIC DEVICE, AND COMPUTER READABLE RECORDING MEDIUM

(71) Applicant: Samsung Electronics Co., Ltd., Suwon-si (KR)

(72) Inventors: Yong-Sang YUN, Suwon-si (KR); Chi-Hyun CHO, Suwon-si (KR); Chang-Ryong HEO, Suwon-si (KR)

(73) Assignee: Samsung Electronics Co., Ltd., Suwon-si (KR)

(21) Appl. No.: 14/249,595

(22) Filed: Apr. 10, 2014

(30) Foreign Application Priority Data
Dec. 5, 2013 (KR) 10-2013-0150532

(51) Int. Cl. G06F 3/01; G06F 3/0488; H04L 29/08; G06F 3/0484

(52) U.S. Cl. CPC G06F 3/017; G06F 3/0484; G06F 3/0488; H04L 67/025

(57) ABSTRACT

A method of performing a function of an electronic device, an electronic device, and a computer readable recording medium are provided. The method includes detecting a signal generated by a user gesture, identifying the user gesture by analyzing a waveform of the detected signal, and performing a function corresponding to the identified user gesture. The various embodiments of the present disclosure may be replaced by other embodiments.

### CROSS-REFERENCE TO RELATED APPLICATION(S)

This application claims the benefit under 35 U.S.C. §119(a) of a Korean patent application filed on Dec. 5, 2013 in the Korean Intellectual Property Office and assigned Serial number 10-2013-0150532, which was the entire disclosure of which is hereby incorporated by reference.

### TECHNICAL FIELD

The present disclosure relates to a method of recognizing a user's gesture through an electronic device, an electronic device, and a computer readable recording medium.

### BACKGROUND

Recently, various services and additional functions provided by an electronic device (e.g., a mobile device) have gradually expanded. In order to increase an effective value of the electronic device and meet various demands of users, various applications that are executable by the electronic device have been developed.

In a mobile apparatus, basic applications produced by the manufacturer of the mobile apparatus and installed in the corresponding apparatus, and additional applications bought and downloaded from web sites that sells the applications through the Internet may be stored and executed in the mobile apparatus. The additional applications may be developed by general developers and registered in the website that sells applications. Accordingly, anyone can freely sell developed applications to the user of the mobile apparatus through the website. As a result, mobile apparatuses are currently provided with tens of thousands to hundreds of thousands of applications that are either free of charge or cost a varying amount.

Further, various input interfaces suitable for the electronic device have been developed according to diversification of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for a watch type device that is restricted in that it is difficult, due to a size limit of a screen, to set the screen within the device. Further, methods of executing a function of the electronic device required by a user are not diverse.

Accordingly, an aspect of the present disclosure is to provide a method of recognizing a gesture through an electronic device, an electronic device, and a computer readable recording medium, in which a signal (e.g., a sound or a vibration) generated by a user's gesture is detected by at least one sensor so that the gesture can be recognized.

Another aspect of the present disclosure is to provide a method of recognizing a gesture through an electronic device, an electronic device, and a computer readable recording medium, in which another electronic device can be controlled based on a signal detected by at least one sensor.

Another aspect of the present disclosure is to provide a method of recognizing a gesture through an electronic device, an electronic device, and a computer readable recording medium, in which an input signal is received from another electronic device and information on the received input signal can be displayed.

In accordance with an aspect of the present disclosure, a method of recognizing a gesture through an electronic device is provided. The method includes detecting a signal generated by a user gesture, identifying the user gesture by analyzing a waveform of the detected signal, and performing a function corresponding to the identified user gesture.

In accordance with another aspect of the present disclosure, a method of recognizing a gesture through an electronic device is provided. The method includes detecting a signal generated by a user gesture, identifying a type of a second electronic device to be controlled, based on a waveform of the detected signal, connecting the electronic device with the second electronic device through a communication unit, and controlling the second electronic device.

In accordance with another aspect of the present disclosure, an electronic device is provided. The electronic device includes a sensor configured to detect a signal generated by a user gesture, and a controller configured to identify the user's gesture by analyzing a waveform of the detected signal and to control a function corresponding to the identified user gesture.

In accordance with another aspect of the present disclosure, an electronic device is provided. The electronic device includes a communication unit, a sensor configure to detect a signal generated by a user gesture, and a controller configured to identify a type of a second electronic device to control, based on a waveform of the detected signal, to connect the electronic device with the second electronic device through the communication unit, and to control the second electronic device.

As described above, according to the various embodiments of the present disclosure, the electronic device analyzes a waveform of a signal detected by at least one sensor, thereby conveniently recognizing a user gesture.

Further, according to the various embodiments of the present disclosure, the electronic device can control another electronic device based on a signal detected by at least one sensor.

Moreover, according to the various embodiments of the present disclosure, the electronic device can display information associated with a signal generated by another electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a flowchart illustrating a procedure of performing a function corresponding to a signal generated by a user's gesture in an electronic device according to an embodiment of the present disclosure;

FIG. 3 is a flowchart illustrating a procedure of performing a function corresponding to a signal generated by a user's gesture in an electronic device according to another embodiment of the present disclosure;

FIG. 4 is a flowchart illustrating a process of analyzing a waveform of a signal generated by a user's gesture in an electronic device according to an embodiment of the present disclosure;

FIG. 5 illustrates a waveform of signals detected by one sensor in an electronic device according to an embodiment of the present disclosure;

FIG. 6 illustrates a waveform of signals detected by two sensors in an electronic device according to an embodiment of the present disclosure;

FIG. 7 illustrates an example of a user's gesture according to an embodiment of the present disclosure;

FIGS. 8, 9, 10, and 11 illustrate examples of a user's gesture according to other embodiments of the present disclosure;

FIG. 12 illustrates an example of wearing an electronic device according to an embodiment of the present disclosure;

FIG. 13 illustrates an example of various applications displayed on a watch type device in which a screen is set according to an embodiment of the present disclosure;

FIG. 14 illustrates an example in which an electronic device operates by detecting a signal generated by a user's gesture according to an embodiment of the present disclosure;

FIG. 15 is a flowchart illustrating an operation in which an electronic device according to an embodiment of the present disclosure controls another electronic device;

FIG. 16 is a signal flow diagram illustrating a procedure of providing information associated with control of an electronic device according to an embodiment of the present disclosure;

FIG. 17 is a signal flow diagram illustrating a procedure of providing information associated with display of an electronic device according to an embodiment of the present disclosure;

FIG. 18 illustrates a waveform of signals detected by a sensor in an electronic device according to another embodiment of the present disclosure;

FIG. 19 illustrates information associated with a tap according to an embodiment of the present disclosure;

FIG. 20 illustrates an example associated with a short distance network according to an embodiment of the present disclosure;

FIG. 21 illustrates an example in which an electronic device controls another electronic device according to an embodiment of the present disclosure;

FIG. 22 is a block diagram illustrating a detailed structure of an electronic device according to an embodiment of the present disclosure;

FIG. 23 illustrates an example of a wearable device according to an embodiment of the present disclosure; and

FIGS. 24, 25, 26, 27, and 28 illustrate examples of a wearable device according to other embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of have various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly indicates otherwise. Thus, for example, reference to “a component surface” includes reference to one or more of such surfaces.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various embodiments of the present disclosure are related to a method and a device in which a waveform of a signal detected by at least one sensor is analyzed so that a user's gesture can be conveniently recognized.

Further, various embodiments of the present disclosure relate to a method and a device in which an electronic device can control another electronic device based on a signal detected by at least one sensor.

In descriptions of the various embodiments of the present disclosure, an electronic device may be an arbitrary device including at least one processor, and may include a camera, a portable device, a mobile terminal, a communication terminal, a portable communication terminal, a portable mobile terminal, and the like. For example, the electronic device may be a digital camera, a smart phone, a mobile phone, a game machine, a TeleVision (TV), a display device, a head unit for a vehicle, a notebook computer, a laptop computer, a tablet computer, a Personal Media Player (PMP), a Personal Digital Assistant (PDA), a navigation device, an Automated Teller Machine (ATM) of a bank, a Point-Of-Sale (POS) device of a shop, or the like.

Further, the electronic device according to the various embodiments of the present disclosure may be a flexible device or a flexible display device. Furthermore, the electronic device according to the embodiments of the present disclosure may also be a wearable device (e.g., a watch type device, a glass type device, a clothing type device, and the like).

Moreover, the electronic device can detect a signal generated by a user's touch according to an embodiment of the present disclosure, and the touch may include a user's gesture (e.g., a swipe, a tap, and the like). The touch may mean that a user directly touches his body part, for example, with his hand, and may also mean that a user directly touches his body part, for example, with his hand on which a glove is worn.

Hereinafter, various embodiments of the present disclosure will be described in detail with reference to the accompanying drawings such that those skilled in the art to which the present disclosure pertains may easily carry out the present disclosure.

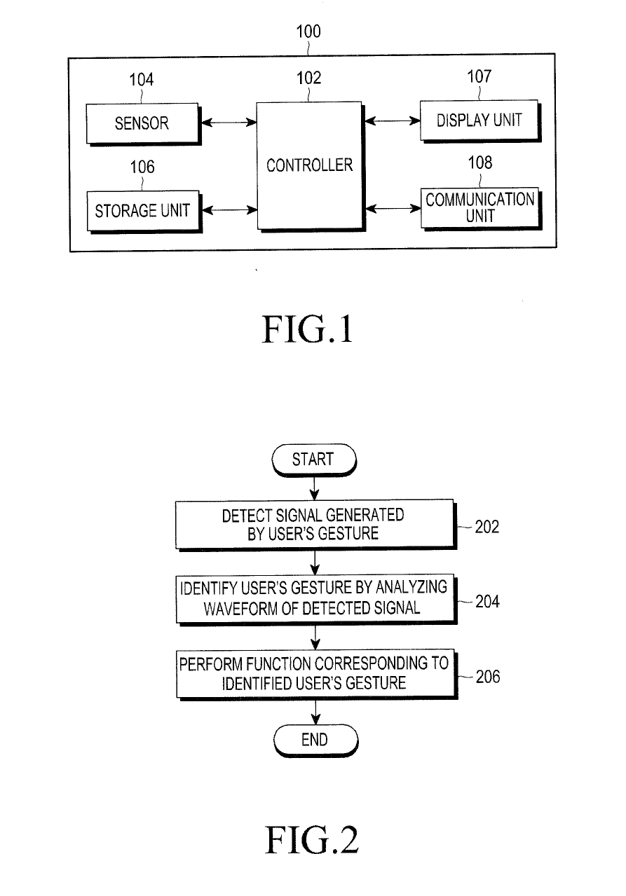

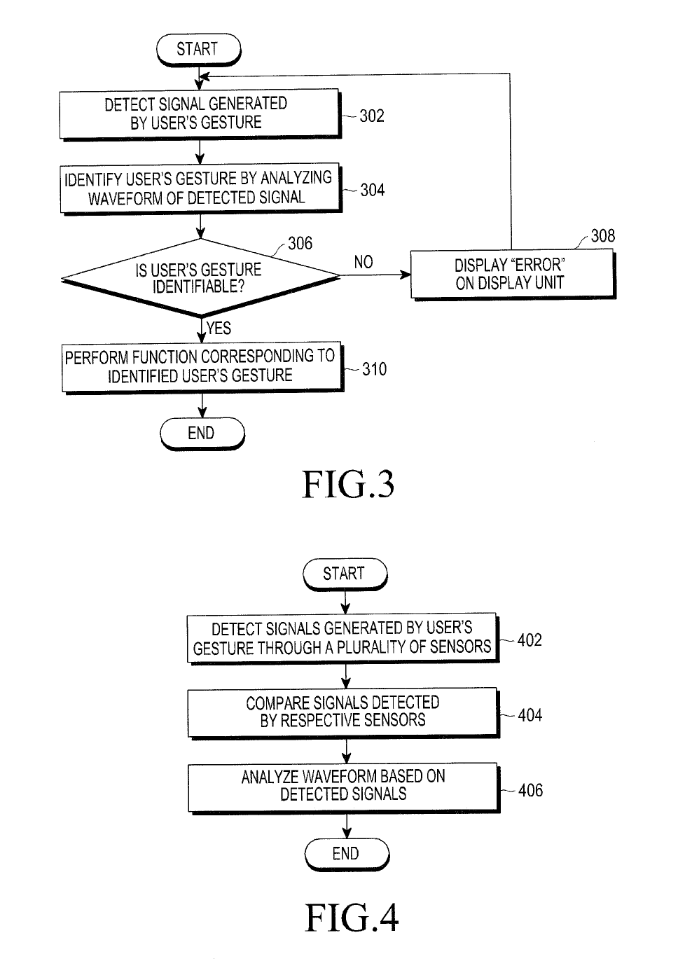

First, a configuration of an electronic device according to an embodiment of the present disclosure will be described with reference to FIG. 1, and thereafter procedures according to various embodiments of the present disclosure will be described in detail with reference to FIGS. 2 to 4. Meanwhile, although a wearable device (e.g., a watch type device) will be described as an example of the electronic device in the below description, various embodiments of the present disclosure are not limited to the wearable device (e.g., the watch type device).

FIG. 1 is a block diagram illustrating a configuration of an electronic device according to an embodiment of the present disclosure.

Referring to FIG. 1, the electronic device 100 according to the embodiment of the present disclosure may include a controller 102 and a sensor 104. Further, according to another embodiment of the present disclosure, the electronic device 100 may also further include a storage unit 106, a display unit 107, and a communication unit 108.

According to an embodiment of the present disclosure, when the electronic device 100 is worn on a user's body part, the controller 102 may judge which body part (e.g., a right or left wrist) the electronic device 100 is being worn on. The controller 102 may analyze a waveform of a signal detected by the sensor 104 and may control the electronic device 100 to perform an operation corresponding to the analyzed waveform.

The controller 102 may analyze the detected signal based on the signal sensed by the sensor 104 and may control such that a processing result according to the analysis of the detected signal may be directly applied to the display unit 107. The controller 102 may control the storage unit 106 to store the detected signal and may also analyze the signal stored in the storage unit 106 to display the analysis result on the display unit 107.

Further, the controller 102 may be connected with another electronic device by controlling the communication unit 108 and may be connected with the another electronic device through various communication networks such as a Personal Area Network (PAN), a Local Area Network (LAN), a Metropolitan Area Network (MAN), a Wide Area Network (WAN), and the like.

Further, the controller 102 may also use a wireless transmission technology used in short distance communication such as Infrared Data Association (IrDA) or Bluetooth by controlling the communication unit 108.

Further, the controller 102 may also receive a signal of another electronic device through a cable broadcasting communication network, a terrestrial broadcasting communication network, a satellite broadcasting communication network or the like by controlling the communication unit 108 and may control an overall operation of the electronic device 100.

The sensor 104 may detect a signal generated by a user's gesture. The sensor 104 may transfer the detected signal to the controller 102.

The sensor 104 may include, for example, a microphone device, an input device, and a mono input device, and is not limited to the aforementioned devices.

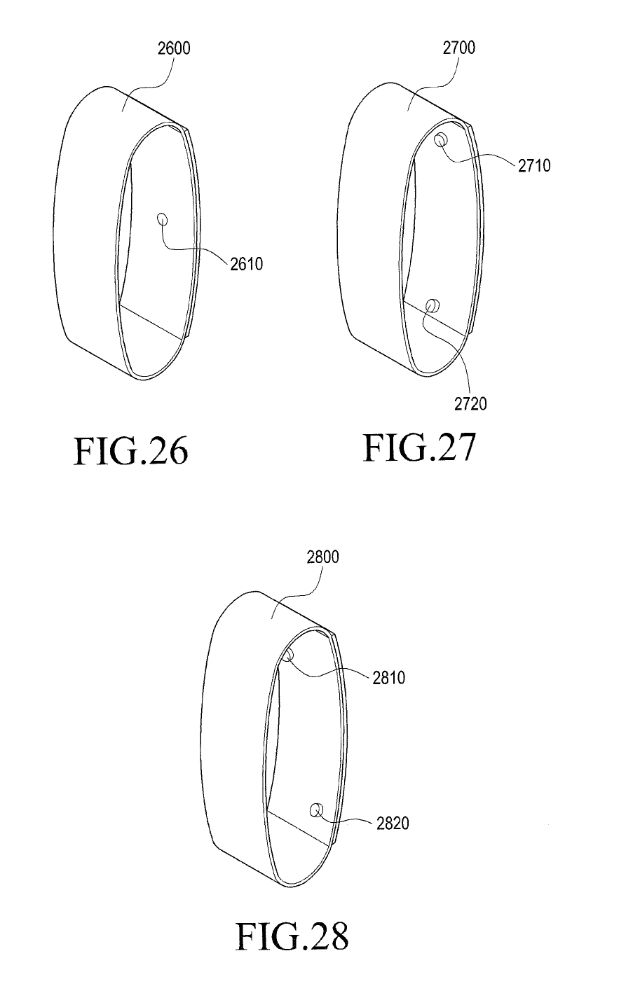

Meanwhile, the electronic device 100 according to the embodiment of the present disclosure may include a single sensor 104, but may also include a plurality of sensors as illustrated in FIGS. 24 to 27, without being limited thereto.

Accordingly, the storage unit 106 may store a signal input through the control of the controller 102, the display unit 107 may display a result according to the signal, and the communication unit 108 may perform an operation for a connection with another electronic device under the control of the controller 102.

FIG. 2 is a flowchart illustrating a procedure of performing a function corresponding to a signal generated by a user's gesture in an electronic device according to an embodiment of the present disclosure.

Referring to FIG. 2, the electronic device (e.g., a wearable electronic device including a watch type device, etc.) detects a signal (e.g., a sound and a vibration) generated by a user's gesture in operation 202. For example, the electronic device may detect a signal generated by friction of a user, and may also detect another external signal, without being limited thereto. Accordingly, the electronic device may identify a type of user's gesture (e.g., a tap, a swipe in a predetermined direction, and the like) based on the detected signal.

As described above, in order to identify the type of user's gesture, the electronic device may analyze a waveform of the detected signal to identify the user's gesture, in operation 204. Thereafter, the electronic device may perform a function corresponding to the identified user's gesture, in operation 206.

As described above, the electronic device performs the operation corresponding to the analyzed waveform according to the embodiment of the present disclosure, thereby conveniently recognizing the user's gesture.

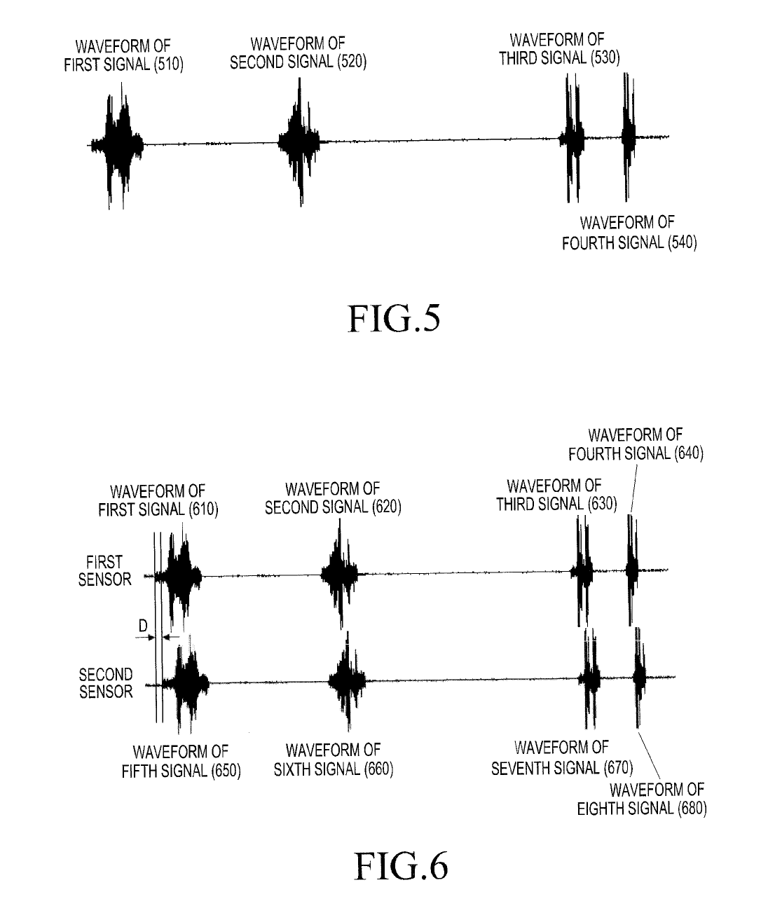

FIG. 3 is a flowchart illustrating a procedure of performing a function corresponding to a signal generated by a user's gesture in an electronic device according to another embodiment of the present disclosure.

Referring to FIG. 3, the electronic device (e.g., a wearable electronic device including a watch type device, etc.) detects a signal (e.g., a sound and a vibration) generated by a user's gesture in operation 302. For example, the electronic device may detect a signal generated by friction of a user, and may also detect another external signal, without being limited thereto. Accordingly, the electronic device may identify a type of user's gesture based on the detected signal.

As described above, in order to identify the type of user's gesture, the electronic device may analyze a waveform of the detected signal to identify the user's gesture in operation 304. At this time, the electronic device may judge in operation 306 whether the user's gesture can be identified. When the user's gesture may be identified, the electronic device performs a function corresponding to the identified user gesture in operation 310. On the other hand, when the user's gesture may not be identified, the electronic device may display an error message such as “Error” on a display unit in operation 308. When “the error message is displayed on the display unit as described above, the user may judge that the electronic device has not recognized the gesture. However, various embodiments of the present disclosure are not limited thereto.

Meanwhile, the electronic device may perform a function corresponding to the identified user's gesture as follows.

TABLE 1

| Mode | User's gesture | Function |
|---|---|---|
| Standby | Tap | Release standby mode |
| mode | Left → Right | Change to rightward standby mode |
| | Right → Left | Change to leftward standby mode |
| | Up → Down | Setting for decrease in standby mode time |
| | Down → UP | Setting for increase in standby mode time |
| Watch mode | Tap | Luminous Mode |
| | Left → Right | Change to First Mode |
| | Right → Left | Change to Second mode |
| | Up → Down | Decrease luminous brightness |
| | Down → Up | Increase luminous brightness |
| Video mode | Tap | Reproduce/Suspend video image |
| | Left → Right | Reproduce next video image |
| | Right → Left | Reproduce previous video image |
| | Up → Down | Volume down |
| | Down → Up | Volume up |
| . . . | . . . | . . . |

Referring to Table 1, in each mode, the electronic device may analyze a signal generated by a user's gesture to perform a preset function for the corresponding mode in correspondence to the analyzed signal.

For example, when detecting a signal generated by a user's tap gesture in a standby mode, the electronic device may analyze a waveform of the detected signal to identify that the user's gesture corresponds to the tap gesture, according to an embodiment of the present disclosure. At this time, because it has been set such that the standby mode is released when the tap gesture is input in the standby mode as illustrated in Table 1, the standby mode may be released according to the waveform analysis. As described above, the user may perform the desired function by contact of the user's body without an input through a separate input unit of the electronic device.

According to another embodiment of the present disclosure, when detecting a signal generated by a user's gesture of swiping at the user's body part (e.g., the back of the hand, the wrist, the inside of the wrist, the palm of the hand, the arm, the finger, the finger tip, the nail, and the like) from left to right in the standby mode, the electronic device may analyze a waveform of the detected signal to identify that the user's gesture corresponds to a tap gesture. At this time, since it has been set such that the standby mode changes to a rightward standby mode (e.g., a screen converted rightward in the standby mode) when the swiping gesture from left to right is input in the standby mode as illustrated in Table 1, a screen may be changed according to the waveform analysis. As described above, the user may perform the desired function using the contact of the user's body without an input through a separate input unit of the electronic device.

Further, according to various embodiments of the present disclosure, a function for the set modes may be changed according to a user's body part (e.g., a location where a user's gesture is generated). For example, when a gesture of swiping at the back of a user's hand from left to right is input in a standby mode, the standby mode may change to a rightward standby mode (e.g., a screen converted rightward in the standby mode). However, when a gesture of swiping at a user's arm from left to right is input in a standby mode, a standby mode time may be decreased. As described above, according to the various embodiments of the present disclosure, it may be set such that, despite the user's same gestures, various functions may be performed according to the locations where the gestures are generated. For example, in a case of a Digital Multimedia Broadcasting (DMB) application, channel setting may be performed when a user's gesture is generated on the back of the hand and volume adjustment may be performed when a user's gesture is generated on the arm. As described above, when recognizing the user's gesture, the electronic device may perform the function corresponding to the user's gesture according to the corresponding mode. As illustrated in Table 1, corresponding functions may be performed for the watch mode, the video mode, and the standby mode. However, embodiments of the present disclosure are not limited thereto. For example, the corresponding mode according to the embodiment of the present disclosure may include a standby mode, a watch mode, a video mode, a music mode, a motion mode, a telephone call mode, a photographing mode, a short distance communication connecting mode, and the like, without being limited thereto.

Further, the modes set may be configured such that one mode is executed on a screen, and may also be configured such that a plurality modes are executed on a screen. Furthermore, the identifiable type of user's gesture according to the embodiment of the present disclosure is not limited to the aforementioned tap or swipe gesture, and the embodiments of the present disclosure may also be applied to any type of user's gesture which can be identified by generating a signal.

As described above, the electronic device performs the operation corresponding to the analyzed waveform according to the embodiment of the present disclosure, thereby conveniently recognizing the user's gesture.

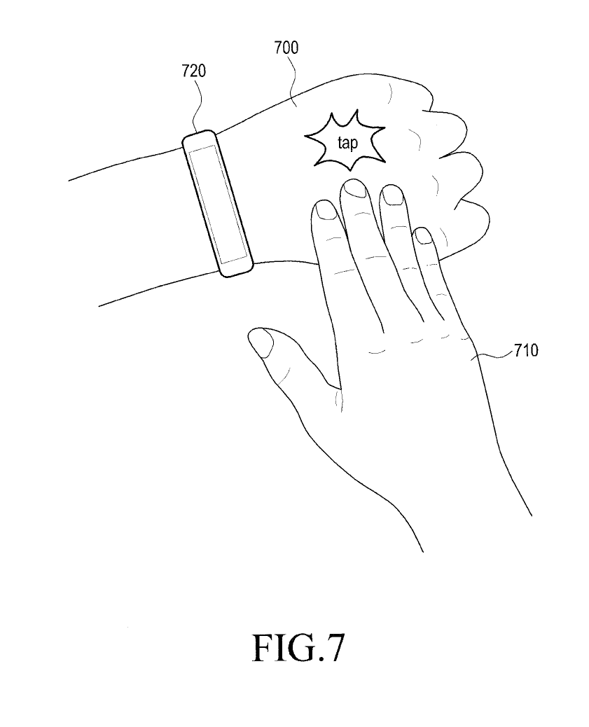

FIG. 4 is a flowchart illustrating a process of analyzing a waveform of a signal generated by a user's gesture in an electronic device according to an embodiment of the present disclosure.

Referring to FIG. 4, the electronic device (e.g., a wearable electronic device including a watch type device, etc.) detects signals that generated by a user's gesture (e.g., a sound and a vibration) through a plurality of sensors in operation 402. For example, the electronic device may detect a signal generated by friction of a user and may also detect another external signal without being limited thereto. Accordingly, the electronic device may identify a type of user's gesture based on the detected signals.

The electronic device may detect the signals generated by the user through the plurality of sensors. The electronic device may compare the signals detected through the respective sensors in operation 404. Thereafter, the electronic device may analyze a waveform of the detected signals in operation 406.

As described above, the electronic device analyzes the signals detected through the plurality of sensors according to the embodiment of the present disclosure, thereby conveniently recognizing the user's gesture.

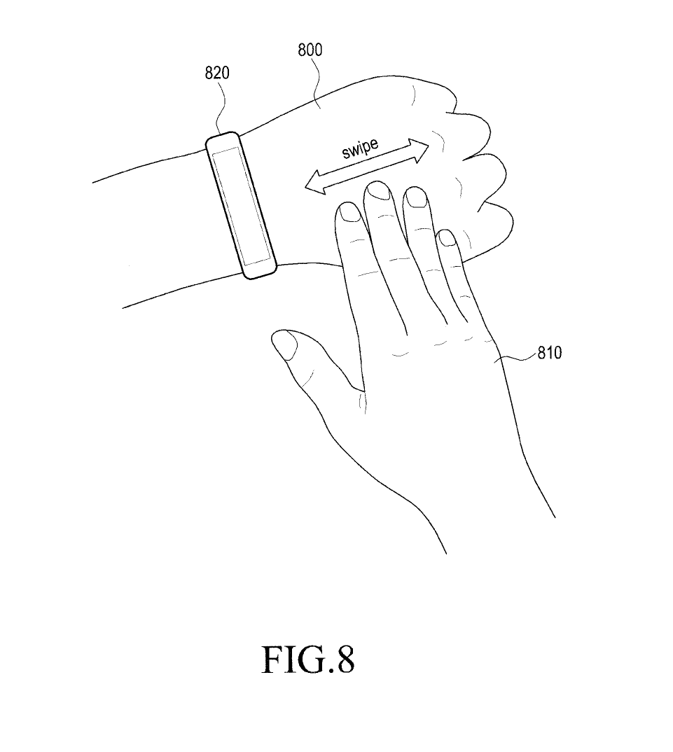

FIG. 5 illustrates a waveform of signals detected by one sensor in an electronic device according to an embodiment of the present disclosure.

Referring to FIG. 5, waveforms may correspond to a waveform of signals for identifying a user's gestures performed on the user's body part. The user's gestures may include, for example, a downward swipe, an upward swipe, a rightward swipe, a leftward swipe, and a tap, without being limited thereto, and the user's body part may be, for example, the back of the hand, the wrist, the inside of the wrist, the palm of the hand, the arm, the finger, the finger tip, the nail, or the like, without being limited thereto.

A waveform 510 of a first signal detected by the sensor may represent a signal generated by a downward swipe gesture, a waveform 520 of a second signal detected by the sensor may represent a signal generated by a rightward swipe gesture, and waveforms 530 and 540 of third and fourth signals, respectively, detected by the sensor may represent signals generated by tap gestures. Although the waveform for the signals are displayed as the waveform for the first, second, third, and fourth signals in FIG. 5, the present disclosure is not limited thereto, and the first, second, third, and fourth signals may have different forms according to a user.

Meanwhile, the electronic device may store signals generated according to a user's habit (e.g., movement of a user's finger, movement of a user's palm, and the like), map various functions (e.g., music playback, music stop, application execution, application stop, and the like) onto the respective signals, and store the mapped signals, thereby easily controlling the various functions based on the user's gesture.

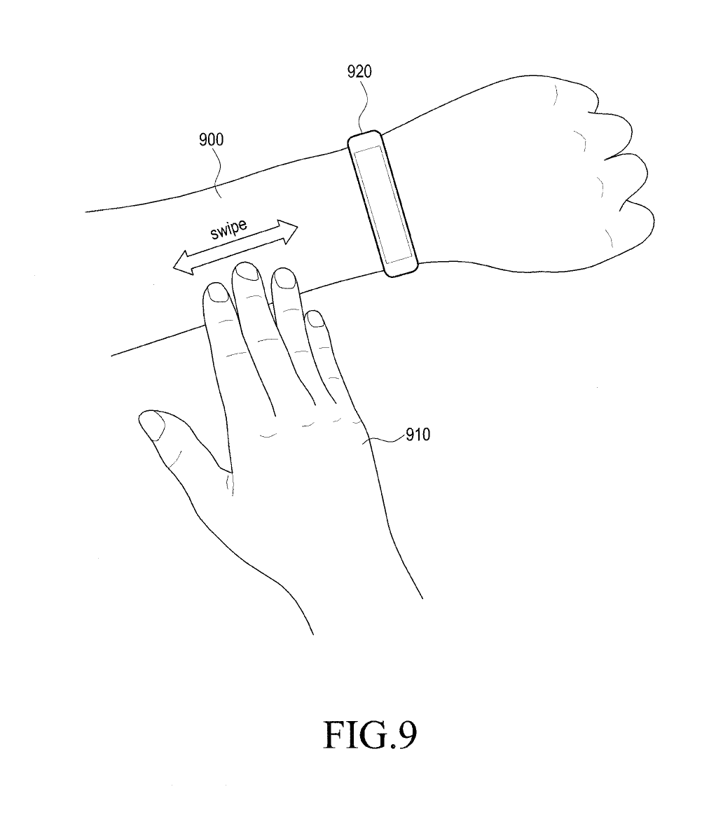

FIG. 6 illustrates a waveform of signals detected by two sensors in an electronic device according to an embodiment of the present disclosure.

Referring to FIG. 6, the waveforms may correspond to a waveform of signals for identifying a user's gestures performed on the user's body part. The user's gestures may include, for example, a downward swipe, an upward swipe, a rightward swipe, a leftward swipe, and a tap, without being limited thereto, and the user's body part may be, for example, the back of the hand, the wrist, the inside of the wrist, the palm of the hand, the arm, the finger, the finger tip, the nail, or the like, without being limited thereto.

A waveform 610 of a first signal detected by a first sensor may represent a signal generated by a downward swipe gesture, a waveform 620 of a second signal detected by the first sensor may represent a signal generated by a rightward swipe gesture, and waveforms 630 and 640 of third and fourth signals, respectively, detected by the first sensor may represent signals generated by tap gestures.

Further, a waveform 650 of a fifth signal detected by a second sensor may represent a signal generated by a downward swipe gesture, a waveform 660 of a sixth signal detected by the second sensor may represent a signal generated by a rightward swipe gesture, and waveforms 670 and 680 of seventh and eighth signals, respectively, detected by the second sensor may represent signals generated by tap gestures.

As illustrated in FIG. 6, a direction of the user's gesture may be determined through comparison of the waveform of the signals detected by the plurality of sensors. Although FIG. 6 illustrates the waveform of the signals detected by the two sensors, the sensors may include at least two sensors, without being limited thereto.

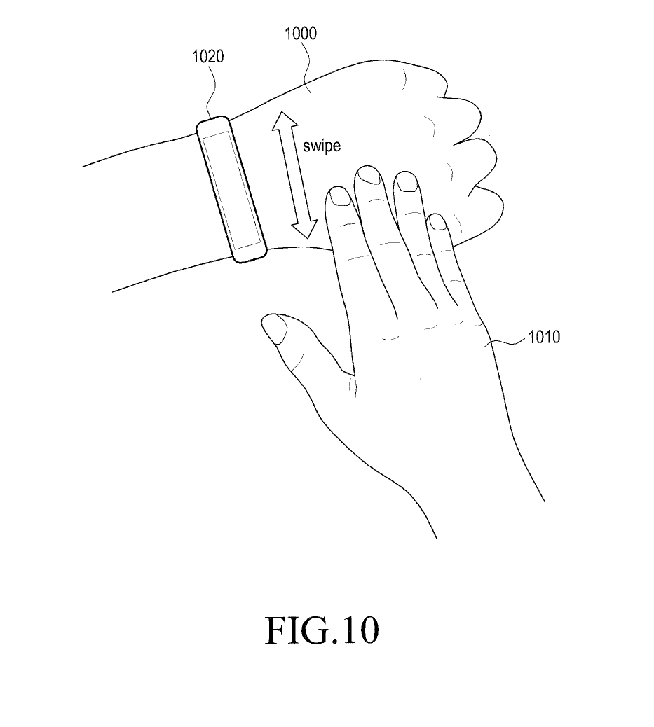

FIG. 7 illustrates an example of a user's gesture according to an embodiment of the present disclosure.

Referring to FIG. 7, an electronic device 720 is worn on a user's wrist. The electronic device may also be worn, for example, on the back of the hand, the inside of the wrist, the palm of the hand, the arm, the finger, the finger tip, or the nail of the user, without being limited thereto. The electronic device 720 may identify a sound, a vibration, and the like according to a user's gesture 710 (e.g., a tap) performed on the user's body part (e.g., the back of the hand 700, the wrist, the inside of the wrist, the palm of the hand, the arm, the finger, the finger tip, and the nail, without being limited thereto). A tap according to another embodiment of the present disclosure may be a gesture of shortly and lightly tapping a screen or a portion (e.g., a corner portion) of the electronic device with a finger.

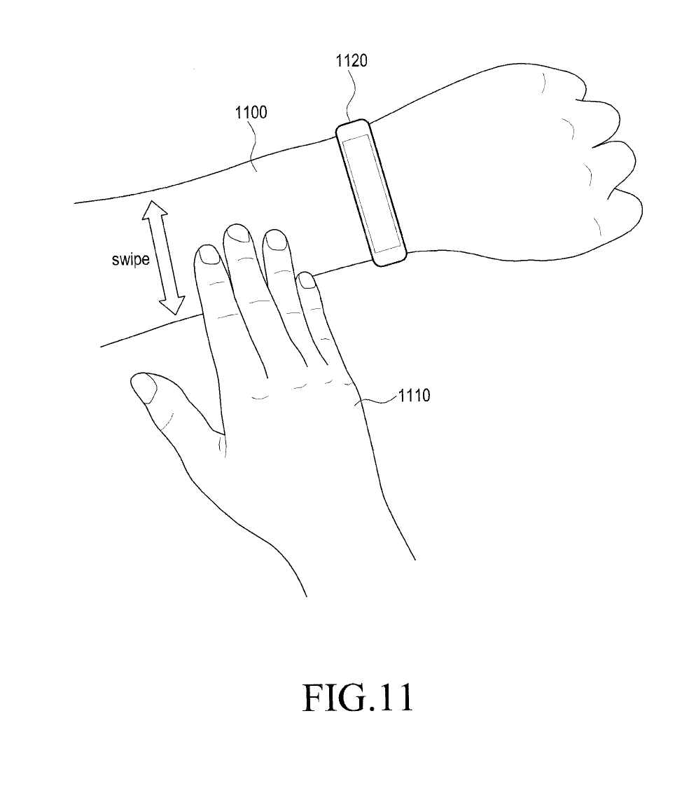

FIGS. 8, 9, 10, and 11 illustrate examples of a user's gesture according to other embodiments of the present disclosure.

Referring to FIGS. 8 to 11, an electronic device is worn on a user's wrist, and may determine a location, a direction, a movement characteristic, and the like of various gestures on the back of the hand, the wrist, and the like of the user. The electronic device may also perform other commands corresponding to the location, the direction, the movement, and the like of the various gestures, and may also detect the direction in which the gesture has been generated (e.g., a leftward direction, a rightward direction, a downward direction, an upward direction, a diagonal direction, or the like).

Referring to FIG. 8, an electronic device 820 is worn on a user's wrist. The electronic device may also be worn, for example, on the back of the hand, the inside of the wrist, the palm of the hand, the arm, the finger, the finger tip, or the nail of the user, without being limited thereto. The electronic device 820 may identify a signal such as a sound, a vibration, and the like according to a user's rightward swipe gesture 810 performed on the user's body part (e.g., the back of the hand 800, the wrist, the inside of the wrist, the palm of the hand, the arm, the finger, the finger tip, and the nail, without being limited thereto) and may analyze the detected signal, thereby identifying the swipe gesture and the direction thereof. Meanwhile, as illustrated in FIG. 8, the swipe according to the embodiment of the present disclosure may be a gesture that the user touches a screen of the electronic device with his hand and then horizontally or vertically moves the hand.

Referring to FIG. 9, an electronic device 920 is worn on a user's wrist. The electronic device may also be worn, for example, on the back of the hand, the inside of the wrist, the palm of the hand, the arm, the finger, the finger tip, or the nail of the user, without being limited thereto. The electronic device 920 may identify a signal generated by a sound, a vibration, and the like according to a user's rightward or leftward swipe gesture 910 performed on the user's body part (e.g., the wrist 900, the back of the hand, the inside of the wrist, the palm of the hand, the arm, the finger, the finger tip, and the nail, without being limited thereto).

Referring to FIG. 10, an electronic device 1020 is worn on a user's wrist. The electronic device may also be worn, for example, on the back of the hand, the inside of the wrist, the palm of the hand, the arm, the finger, the finger tip, or the nail of the user, without being limited thereto. The electronic device 1020 may identify a signal generated by a sound, a vibration, and the like according to a user's downward or upward swipe gesture performed on the user's body part (e.g., the back of the hand 1000, the wrist, the inside of the wrist, the palm of the hand, the arm, the finger, the finger tip, and the nail, without being limited thereto).

Referring to FIG. 11, an electronic device 1120 is worn on a user's wrist. The electronic device may also be worn, for example, on the back of the hand, the inside of the wrist, the palm of the hand, the arm, the finger, the finger tip, or the nail of the user, without being limited thereto. The electronic device 1120 may detect a signal of a sound, a vibration, and the like generated according to a user's downward or upward swipe gesture 1110 performed on the user's body part (e.g., the wrist 1100, the back of the hand, the inside of the wrist, the palm of the hand, the arm, the finger, the finger tip, and the nail, without being limited thereto).

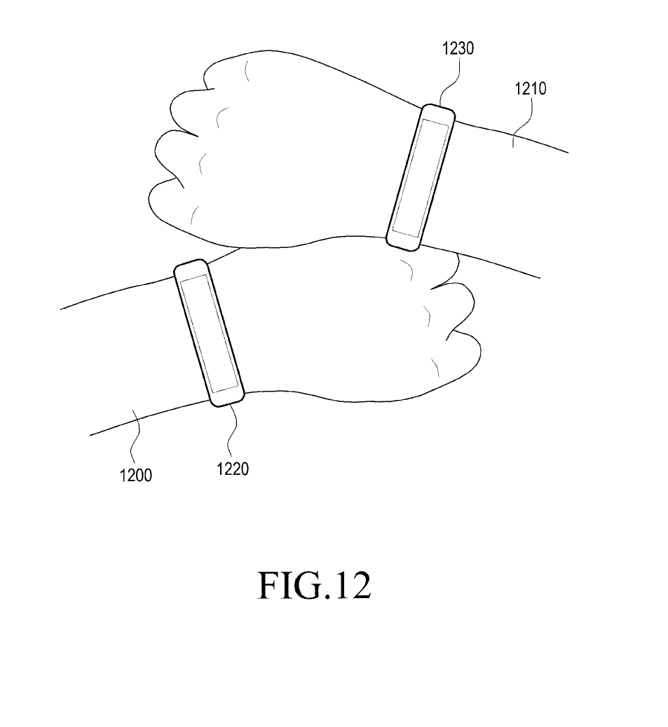

FIG. 12 illustrates an example of wearing an electronic device according to an embodiment of the present disclosure.

Referring to FIG. 12, the electronic device may process a signal detected by a sensor as a based on where a user wears the electronic device. For example, a first electronic device 1230 may be worn on a right wrist 1210 of a user, and a second electronic device 1220 may be worn on a left wrist 1200 of the user. Each of the electronic devices may identify, based on a signal detected by a sensor, if the corresponding electronic device is being worn on the left or right wrist of the user and may process an input user gesture based on where the electronic device is being worn.

Meanwhile, similar signals may be input to the first and second electronic devices 1230 and 1220, respectively. Accordingly, each of the electronic devices may determine a location, a direction, a movement characteristic, and the like of a user's gesture, and at least one sensor of the electronic device according to the embodiment of the present disclosure may detect the location, the direction, the movement characteristic, and the like of the user's gesture. When processing the signal detected by the at least one sensor, the electronic device may also perform a different function according to whether the electronic device is being worn on the right or left wrist of the user.

For example, functions of the electronic device may be configured as follows.

TABLE 2

| | First location | Second | Third location | |
|---|---|---|---|---|
| | (Back of left | location | (Back of right | Fourth location |
| | hand) | (Left arm) | hand) | (Right arm) |
| First | First | Third | Fifth function | Seventh function |
| gesture | function | function | | |
| Second | Second | Fourth | Sixth function | Eighth function |
| gesture | function | function | | |
| . . . | . . . | . . . | . . . | . . . |

When the second electronic device 1220 is worn on the left wrist 1200, the second electronic device 1220 may recognize a location thereof as a first location (the back of the left hand). At this time, the second electronic device may perform a first function if recognizing a first gesture, and may perform a second function if recognizing a second gesture. Further, according to various embodiments of the present disclosure, when the second electronic device 1220 is worn on the left wrist 1200, the second electronic device 1220 may also recognize a location thereof as a second location (the left arm). At this time, the second electronic device may perform a third function if recognizing the first gesture, and may perform a fourth function if recognizing the second gesture.

On the other hand, according to various embodiments of the present disclosure, when the first electronic device 1230 is worn on the right wrist 1210, the first electronic device 1230 may recognize a location thereof as a third location (the back of the right hand). At this time, the first electronic device may perform a fifth function if recognizing the first gesture, and may perform a sixth function if recognizing the second gesture. Further, according to various embodiments of the present disclosure, when the first electronic device 1230 is worn on the right wrist 1210, the first electronic device 1230 may also recognize a location thereof as a fourth location. At this time, the first electronic device may perform a seventh function if recognizing the first gesture and may perform an eighth function if recognizing the second gesture.

The plurality of locations according to the various embodiments of the present disclosure may include, for example, the back of the hand, the wrist, the inside of the wrist, the palm, the arm, the finger, the finger tip, the nail, and the like, and the functions according to the plurality of locations may be configured. For example, the plurality of functions in Table 2 may include the functions illustrated in Table 1 and without being limited thereto, and may be set to include other various functions. Further, the various embodiments of the present disclosure are not limited to the locations and the functions and may be diversely changed.

Meanwhile, although the operation according to the embodiment of the present disclosure may be performed, various operations may also be preset prior to performance of the main operation for performance of a different command according to the location where the electronic device is worn. For example, various operations may be preset by a user's selection based on a User Interface (UI). Further, various operations may also be preset through a button, a touch unit, and the like of the electronic device and may also be preset based on an operation of the electronic device by an internal sensor of the electronic device. The embodiment of the present disclosure is not limited thereto.

Furthermore, the electronic device according to an embodiment of the present disclosure may determine a swinging and specific movement of an arm when a user raises the arm on which the electronic device is worn. Accordingly, the electronic device may also determine the location where the user wears the electronic device by detecting a direction of the swinging and the specific movement of the arm.

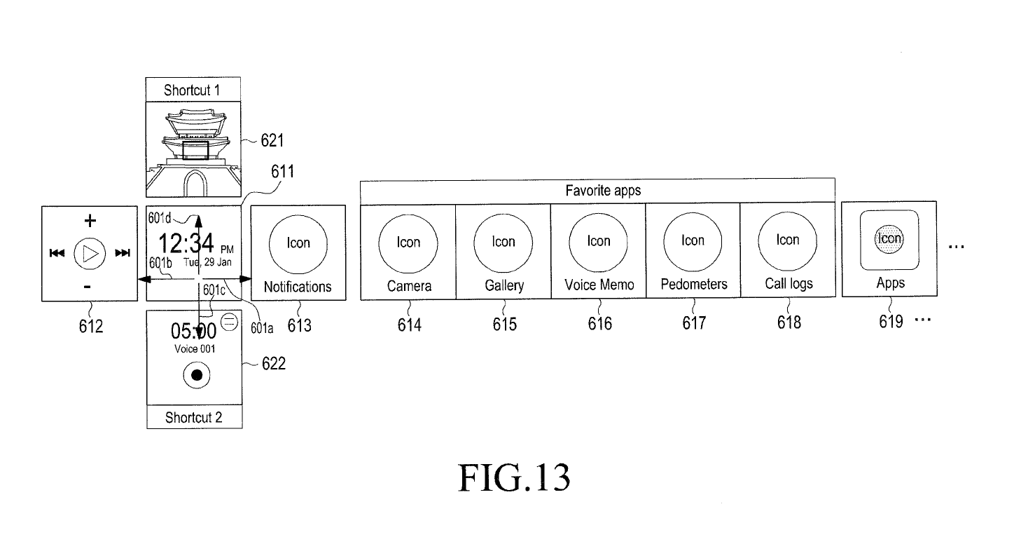

FIG. 13 illustrates an example of various applications displayed on a watch type device in which a screen is set according to an embodiment of the present disclosure.

Referring to FIG. 13, an electronic device 100 may be a watch type device as described above and display a watch application. The electronic device 100 may provide various applications included therein in response to a user input through a touch screen. For example, while a watch application is being displayed, if a gesture corresponding to a first gesture is performed, a music application may be displayed and operated on the touch screen and, if a gesture corresponding to a second gesture is performed, a notification setting application may be displayed and operated on the touch screen. Similarly, if a gesture corresponding to a third gesture is performed, a camera application may be displayed and operated on the touch screen and, if a gesture corresponding to a fourth gesture is performed, a voice memo application may be displayed and operated on the touch screen. In addition, various applications besides the aforementioned applications may also be displayed and operated on the touch screen in response to the user input. For example, a plurality of applications sequentially arranged according to the first or second gesture may be connected and the sequentially arranged applications may also be displayed and operated on the touch screen in a serial order in response to the first or second gesture input.

Further, a bookmark application set by a user may be preferentially arranged in the plurality of applications. Meanwhile, the electronic device 100 may store and manage application setting information including values set for the corresponding application.

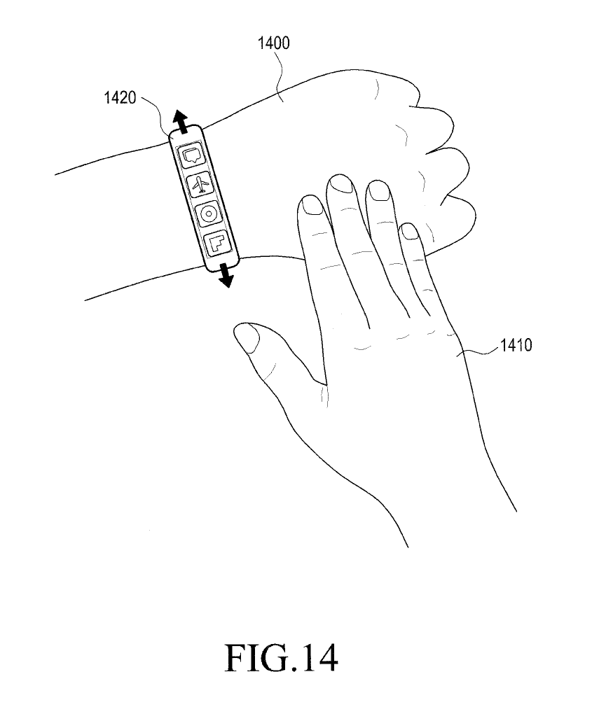

FIG. 14 illustrates an example in which an electronic device operates by detecting a signal generated by a user's gesture according to an embodiment of the present disclosure.

Referring to FIG. 14, the electronic device may be controlled through touching or swiping at a user's body part (e.g., the wrist, the inside of the wrist, the palm, the arm, the finger, the finger tip, and the nail, without being limited thereto) with the user's hand (or the nail, the wrist, the arm, the foot, the top of the foot, the hair, etc., without being limited thereto). For example, the electronic device 1420 may change a User Interface (UI) of a display unit by a user's touch and may perform the touched function.

Further, when detecting an upward and downward swipe, the electronic device 1420 may be operated by the detected swipe and may change a UI changing speed of the display unit according to a speed and a time interval of the swipe.

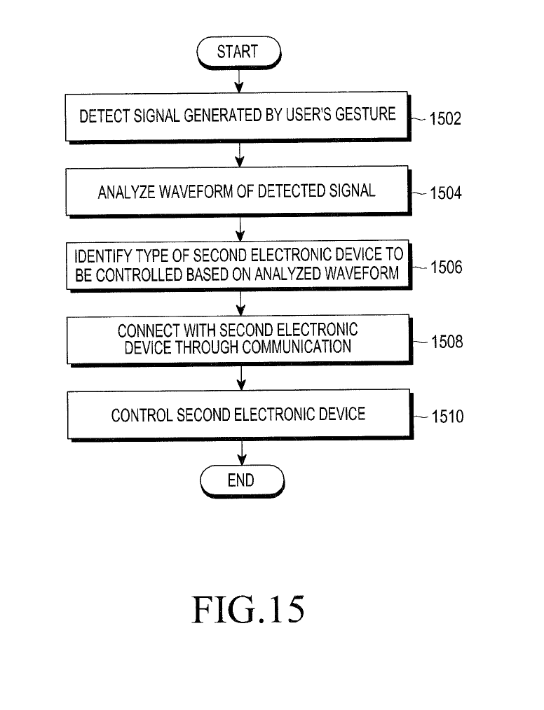

FIG. 15 is a flowchart illustrating an operation in which an electronic device according to an embodiment of the present disclosure controls another electronic device.

Referring to FIG. 15, the electronic device (e.g., a wearable electronic device including a watch type device, etc.) may detect a signal (e.g., a sound and a vibration) generated by a user's gesture in operation 1502. For example, the electronic device may detect a signal generated by friction of a user and may also detect another external signal, without being limited thereto. Accordingly, the electronic device may identify a type of user's gesture based on the detected signal.

As described above, in order to identify the type of user's gesture, the electronic device analyzes a waveform of the detected signal in operation 1504. Thereafter, the electronic device identifies a type of second electronic device to be controlled based on the analyzed waveform in operation 1506. The second electronic device may include, for example, a keyboard device, a desk device, a mouse device, a charger, and the like. However, the various embodiments of the present disclosure are not limited to any specific device. When the type of second electronic device is identified as described above, the electronic device may connect with the second electronic device in operation 1508 and may control the second electronic device in operation 1510.

As described above, the electronic device performs the operation corresponding to the analyzed waveform according to the embodiment of the present disclosure, thereby conveniently recognizing the user's gesture.

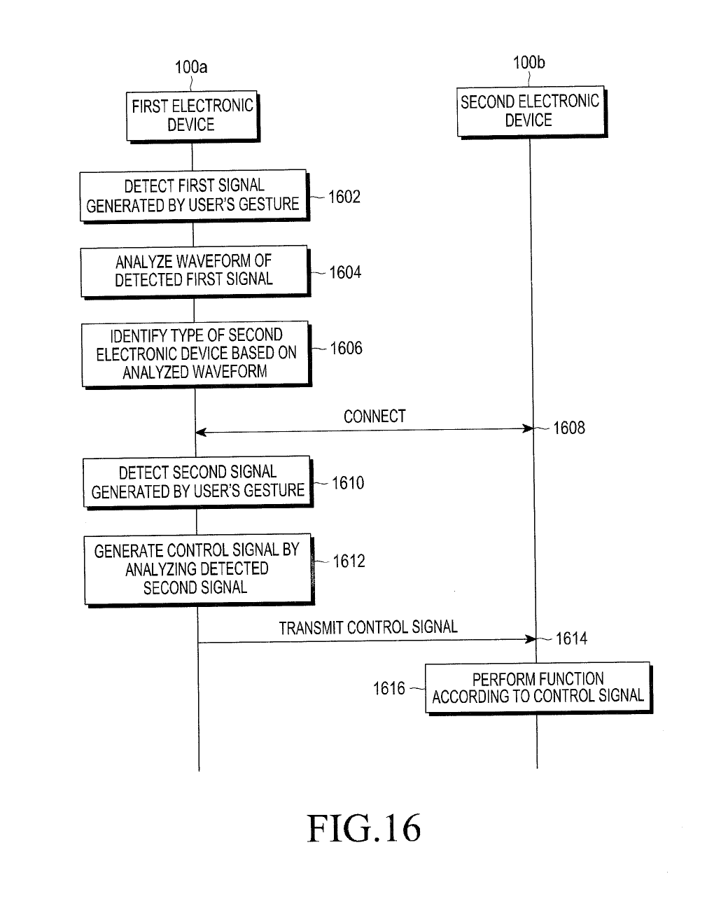

FIG. 16 is a signal flow diagram illustrating a procedure of providing information associated with control of an electronic device according to an embodiment of the present disclosure.

Referring to FIG. 16, a first electronic device 100a (e.g., a wearable electronic device including a watch type device, etc.) detects a first signal (e.g., a sound and a vibration) generated by a user's gesture in operation 1602. For example, the first electronic device 100a may detect a signal generated by friction of a user and may also detect another external signal, without being limited thereto. Accordingly, the first electronic device 100a may identify a type of user's gesture based on the detected signal.

As described above, in order to identify the type of user's gesture, the first electronic device 100a analyzes a waveform of the detected first signal in operation 1604. Thereafter, the first electronic device 100a identifies a type of second electronic device 100b to be controlled based on the analyzed waveform in operation 1606. The second electronic device 100b may include, for example, a keyboard device, a desk device, a mouse device, a charger, and the like. However, the various embodiments of the present disclosure are not limited to any specific device. When the type of second electronic device 100b is identified as described above, the first electronic device 100a may connect with the second electronic device 100b in operation 1608.

Thereafter, the first electronic device 100a (e.g., a wearable electronic device including a watch type device, etc.) may detect a second signal (e.g., a sound and a vibration) generated by a user's gesture in operation 1610. For example, the first electronic device 100a may detect a signal generated by friction of a user and may also detect another external signal, without being limited thereto. Accordingly, the first electronic device 100a generates a control signal by analyzing the detected second signal in operation 1612. Then, the first electronic device 100a transmits the generated control signal to the second electronic device 100b in operation 1614. The second electronic device 100b may perform a function according to the received control signal in operation 1616.

As described above, the electronic device performs the operation corresponding to the analyzed waveform according to the embodiment of the present disclosure, thereby conveniently recognizing the user's gesture.

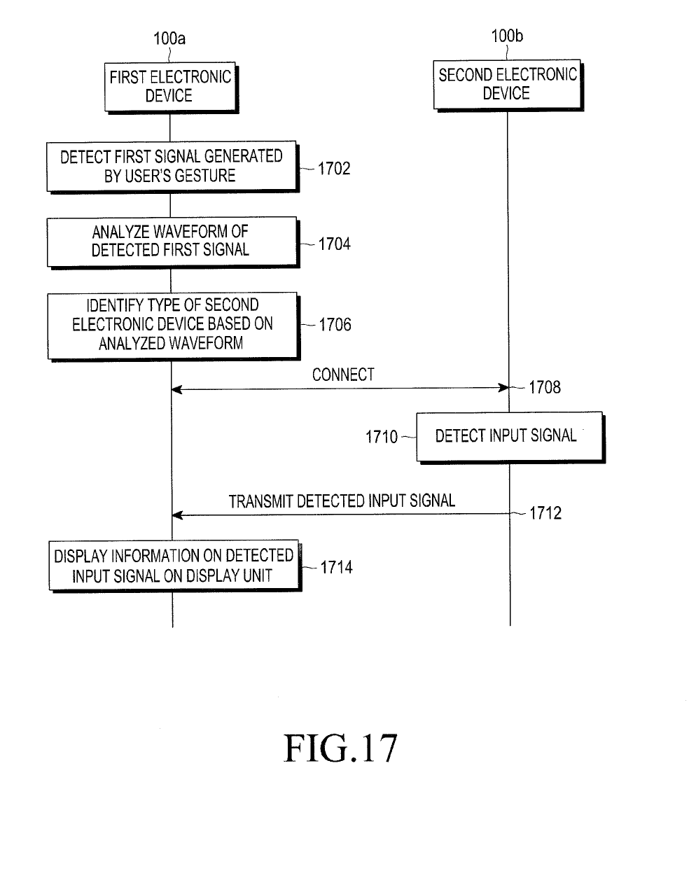

FIG. 17 is a signal flow diagram illustrating a procedure of providing information associated with display of an electronic device according to an embodiment of the present disclosure.

Referring to FIG. 17, a first electronic device 100a (e.g., a wearable electronic device including a watch type device, etc.) detects a first signal (e.g., a sound and a vibration) generated by a user's gesture in operation 1702. For example, the first electronic device 100a may detect a signal generated by friction of a user and may also detect another external signal, without being limited thereto. Accordingly, the first electronic device 100a may identify a type of user's gesture based on the detected signal.

As described above, in order to identify the type of user's gesture, the first electronic device 100a analyzes a waveform of the detected first signal in operation 1704. Thereafter, the first electronic device 100a identifies a type of second electronic device 100b to be controlled based on the analyzed waveform in operation 1706. The second electronic device 100b may include, for example, a keyboard device, a desk device, a mouse device, a charger, and the like. However, the various embodiments of the present disclosure are not limited to any specific device. When the type of second electronic device 100b is identified as described above, the first electronic device 100a may connect with the second electronic device 100b through communication in operation 1708.

Thereafter, when detecting an input signal in operation 1710, the second electronic device 100b transmits the detected input signal to the first electronic device 100a in operation 1712. The first electronic device 100a having received the detected input signal may display information on the detected input signal on a display unit in operation 1714.

As described above, the first electronic device displays the input signal received from the other device on the display unit according to the embodiment of the present disclosure, thereby conveniently recognizing the user's gesture.

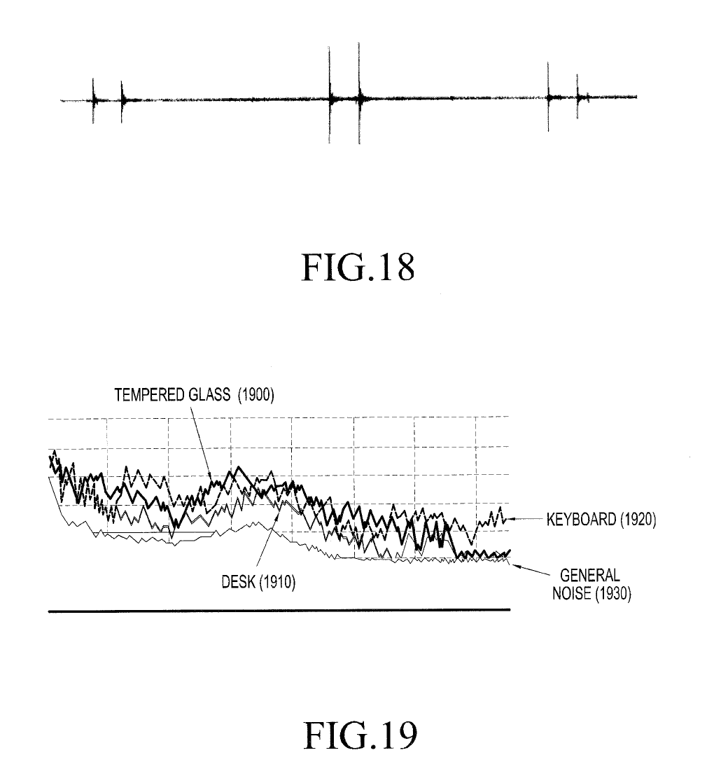

FIG. 18 illustrates a waveform of signals detected by a sensor in an electronic device according to another embodiment of the present disclosure.

Referring to FIG. 18, the waveform of the signals may correspond to a waveform of signals for determination of a user's tap operations performed on various objects. The various objects may include, for example, a tempered glass 1900, a desk 1910, a keyboard 1920, a general noise 1930, and the like. The embodiment of the present disclosure is not limited thereto.

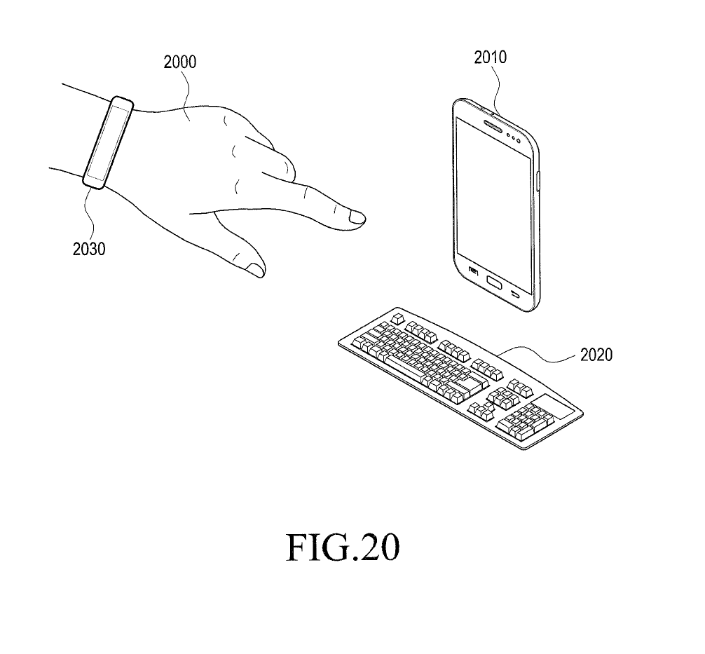

FIG. 19 illustrates information associated with a tap according to an embodiment of the present disclosure.

Referring to FIG. 19, a frequency characteristic of a signal for a user's taps performed on various objects is illustrated. The various objects may include, for example, a tempered glass 1900, a desk 1910, a keyboard 1920, a general noise 1930, and the like. The embodiment of the present disclosure is not limited thereto. Accordingly, the electronic device may recognize the taps on the various objects to perform functions associated with the recognized taps.

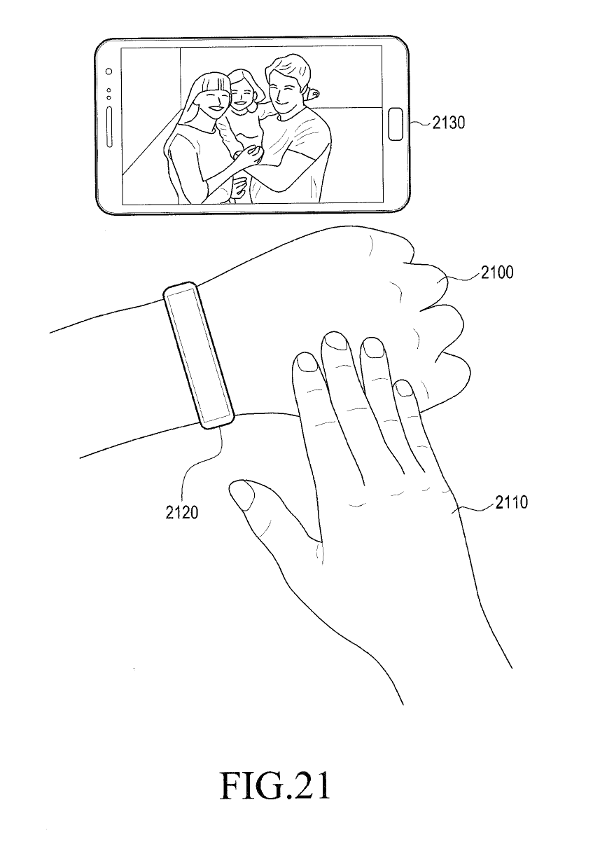

FIG. 20 illustrates an example associated with a short distance network according to an embodiment of the present disclosure.

Referring to FIG. 20, a user may tap a terminal device 2010 and a keyboard 2020 with his hand 2000. For example, the terminal device 2010 and the keyboard 2020 may be exemplified in the embodiment of the present disclosure. However, the present disclosure is not limited thereto. Further, the terminal device 2010 and the keyboard 2020 may include a function capable of performing a short distance network connection according to an embodiment of the present disclosure. Accordingly, an electronic device may be connected with the corresponding object through the short distance network based on a sound caused by the tap on the corresponding object. According to an embodiment of the present disclosure, the keyboard 2020 may be used for the electronic device when a large amount of data is input or data should be rapidly input. The electronic device may detect information on keys of the keyboard 2020 by sensing sound caused by a tap on the keys of the keyboard 2020 and may perform related commands based on the detected information. Namely, the electronic device may prepare in advance information processing based on the sound for the keys of the keyboard 2020 through the connection with the keyboard 2020 and may also store data corresponding to the sound for the keys of the keyboard 2020.

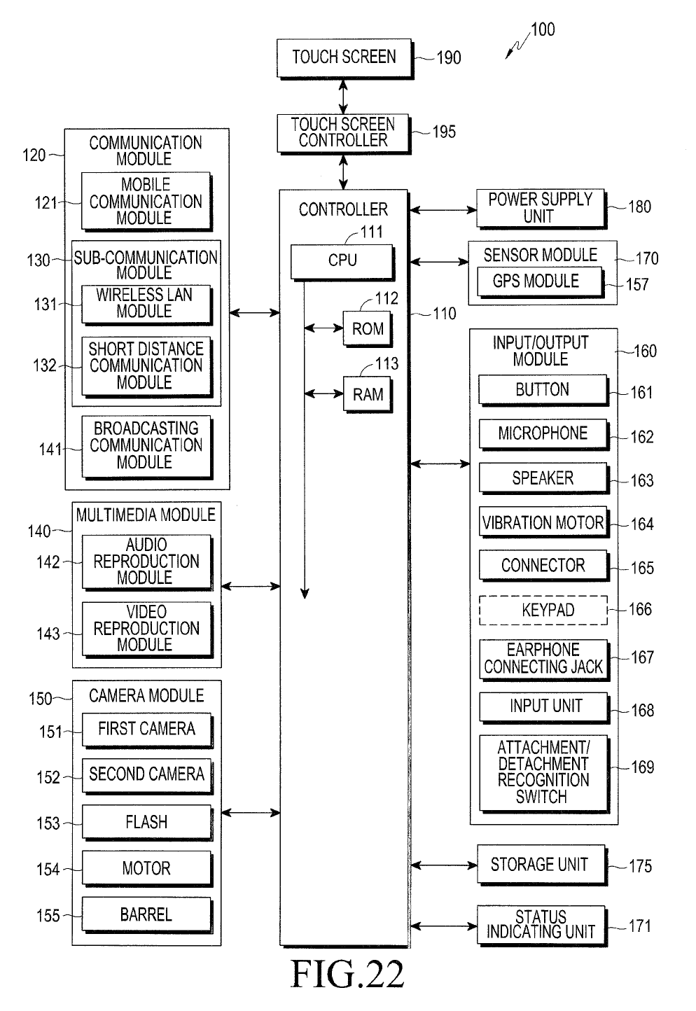

FIG. 21 illustrates an example in which an electronic device controls another electronic device according to an embodiment of the present disclosure.

Referring to FIG. 21, an electronic device 2120 may be connected with an external device 2130. Accordingly, the electronic device 2120 may configure a link with the external device 2130 and may control the connected external device 2130. According to the embodiment of the present disclosure, while a TV screen or a video image is being displayed on the external device 2130, the electronic device 2120 may perform various functions including volume control, viewing channel control, video rewinding, and the like of the corresponding application.

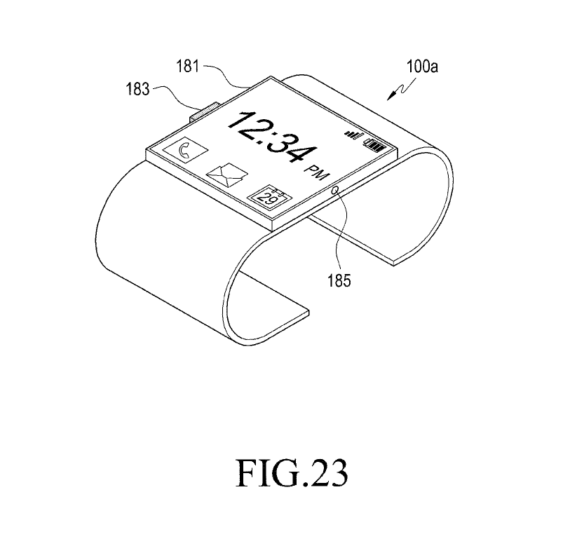

FIG. 22 is a block diagram illustrating a detailed structure of an electronic device according to an embodiment of the present disclosure.

Referring to FIG. 22, the electronic device 100 may be connected with an external electronic device by using at least one of a communication module 120, a connector 165, and an earphone connecting jack 167. The external electronic device may include various devices such as an earphone, an external speaker, a Universal Serial Bus (USB) memory, a charger, a cradle/dock, a DMB antenna, a mobile payment related device, a health management device (blood sugar tester or the like), a game machine, a car navigation device and the like which may be attached to the electronic device 100 through a wire and are removable from the electronic device 100. Further, the electronic device may include a Bluetooth communication device, a Near Field Communication (NFC) device, a Wi-Fi Direct communication device, and a wireless Access Point (AP) which may be wirelessly connected. In addition, the electronic device 100 may be connected with another electronic device or electronic device, for example, one of a mobile phone, a smart phone, a tablet PC, a desktop PC, and a server in a wired or wireless manner.

Further, the electronic device 100 may include at least one touch screen 190 and at least one touch screen controller 195. Further, the electronic device 100 may include a controller 110, a communication module 120, a multimedia module 140, a camera module 150, an input/output module 160, a sensor module 170, a storage unit 175, and a power supply unit 180. The communication module 120 may include a mobile communication module 121, a sub-communication module 130, and a broadcasting communication module 141. The sub-communication module 130 may include at least one of a wireless LAN module 131 and a short distance communication module 132, and the multimedia module 140 may include at least one of an audio reproduction module 142 and a video reproduction module 143. The camera module 150 may include at least one of a first camera 151 and a second camera 152. The input/output module 160 may include at least one of a button 161, a microphone 162, a speaker 163, a vibration device 164, the connector 165, and a keypad 166.

The controller 110 may include a Central Processing Unit (CPU) 111, a Read Only Memory (ROM) 112 for storing a control program for controlling the electronic device 100, and a RAM 113 used as a storage area for storing a signal or data input from the outside of the electronic device 100 or for work performed in the electronic device 100. The CPU 111 may include any suitable number of processing cores such as a single core, a dual core, a triple core, or a quadruple core. The CPU 111, the ROM 112, and the RAM 113 may be connected to each other through an internal bus.

The controller 110 may control at least one of the mobile communication module 120, the multimedia module 140, the camera module 150, the input/output module 160, the sensor module 170, the storage unit 175, the power supply unit 180, the touch screen 190, and a touch screen controller 195.

Further, the controller 110 may detect a user input even such as a hovering event as an input unit 168 that approaches the touch screen 190 or is located close to the touch screen 190. In addition, the controller 110 may detect various user inputs received through the camera module 150, the input/output module 160, and the sensor module 170 as well as the touch screen 190. The user input may include various types of information input into the electronic device 100 such as a gesture, a voice, a pupil action, an iris recognition, and a bio signal of the user as well as the touch. The controller 110 may control a predetermined operation or function corresponding to the detected user's input to be performed within the device 100.

Further, the controller 110 may output a control signal to the input unit 168 or the vibration device 164. The control signal may include information on a vibration pattern, and the input unit 168 or the vibration device 164 generates a vibration according to the vibration pattern. The information on the vibration pattern may indicate the vibration pattern itself or an indicator of the vibration pattern. Alternatively, the control signal may include a request for generating the vibration.

The electronic device 100 may include at least one of the mobile communication module 121, the wireless LAN module 131, and the short distance communication module 132 according to a capability thereof.

The mobile communication module 121 enables the electronic device 100 to be connected with the external device through mobile communication by using one antenna or a plurality of antennas under the control of the controller 110. The mobile communication module 121 may transmit/receive a wireless signal for a voice call, a video call, a Short Message Service (SMS) or a Multimedia Message Service (MMS) to/from a mobile phone with phone numbers input to the electronic device 100, a smart phone, a tablet PC or another electronic device.

The sub-communication module 130 may include at least one of the wireless LAN module 131 and the short distance communication module 132. For example, the sub-communication module 130 may include only the wireless LAN module 131 or only the short distance communication module 132. Alternatively, the sub-communication module 130 may also include both the wireless LAN module 131 and the short distance communication module 132.

The wireless LAN module 131 may be connected to the Internet where a wireless AP is installed. The wireless LAN module 131 may support any wireless LAN standard of the Institute of Electrical and Electronics Engineers (IEEE) such as IEEE802.11ac. The short distance communication module 132 may wirelessly perform near field communication between the electronic device 100 and an external electronic device under the control of the controller 110. A short distance communication scheme may include Bluetooth, Infrared Data Association (IrDA) communication, Wi-Fi-Direct communication, Near Field Communication (NFC) and the like.

The broadcasting communication module 141 may receive a broadcasting signal (e.g., a TV broadcasting signal, a radio broadcasting signal or a data broadcasting signal) or broadcasting additional information (e.g., Electric Program Guide (EPG) or Electric Service Guide (ESG)) that is transmitted from a broadcasting station through a broadcasting communication antenna.

The multimedia module 140 may include the audio reproduction module 142 or the video reproduction module 143. The audio reproduction module 142 may reproduce a digital audio file (for example, a file having a file extension of mp3, wma, ogg, or way) stored in the storage unit 175 or that is received. The video reproduction module 143 may reproduce a digital video file (for example, a file having a file extension of mpeg, mpg, mp4, avi, mov, or mkv) stored or that is received.

The multimedia module 140 may be integrated in the controller 110. The camera module 150 may include at least one of the first camera 151 and the second camera 152 for photographing a still image or a video. Further, the camera module 150 may include at least one of the barrel 155 for performing a zoom-in/out for photographing the subject, the motor 154 for controlling a motion of the barrel 155, and the flash 153 for providing an auxiliary light source required for photographing the subject. The first camera 151 may be disposed on the front surface of the electronic device 100 and the second camera 152 may be disposed on the rear surface of the electronic device 100.

The input/output module 160 may include at least one button 161, at least one microphone 162, at least one speaker 163, at least one vibration device 164, the connector 165, keypad 166, the earphone connection jack 167, and the input unit 168. The input/output module 160 is not limited thereto. A cursor control such as a mouse, a track ball, a joystick, or cursor direction keys may be provided to control cursor movement on the touch screen 190 and may also be included in the sensor unit according to the embodiment of the present disclosure.

The button 161 may be formed on a front surface, a side surface, or a back surface the housing of the electronic device 100 and may include at least one of a power/lock button, a volume button, a menu button, a home button, a back button, and a search button. The microphone 162 receives a voice or a sound to generate an electrical signal. The speaker 163 may output sounds corresponding to various signals or data (for example, wireless data, broadcasting data, digital audio data, digital video data and the like) to the outside of the electronic device 100. The speaker 163 may output a sound (for example, button tone corresponding to phone communication, ringing tone, and a voice of another user) corresponding to a function performed by the electronic device 100. One or more speakers 163 may be formed on a proper position or positions of the housing of the electronic device 100.

The vibration device 164 may convert an electrical signal to a mechanical vibration. For example, the electronic device 100 in a vibration mode operates the vibration device 164 when a voice or video call is received from another device. One vibration device 164 or a plurality of vibration devices 164 may be formed within the housing of the electronic device 100. The vibration device 164 may operate in response to a user input through the touch screen 190.

The connector 165 may be used as an interface for connecting the electronic device 100 with an external electronic device or a power source. The controller 110 may transmit data stored in the storage unit 175 of the electronic device 100 to an external electronic device or may receive data from the external electronic device through a wired cable connected to the connector 165. The electronic device 100 may receive power from a power source through the wired cable connected to the connector 165 or may charge the battery by using the power source.

The keypad 166 may receive a key input from a user to control the electronic device 100. The keypad 166 may include a physical keypad formed in the electronic device 100 or a virtual keypad displayed on the touch screen 190. The physical keypad formed in the electronic device 100 may be excluded according to the capability or structure of the device 100. The earphone may be connected to the electronic device 100 through insertion into the earphone connecting jack 167.

The input unit 168 may be inserted into the electronic device 10 so that it may be withdrawn or separated from the electronic device 100 when it is used. An attachment/detachment recognition switch 169 works in accordance with an installation and attachment/detachment of the input unit 168 and is located in one area within the electronic device 100 into which the input unit 168 is inserted. The attachment/detachment recognition switch 169 may output signals corresponding to the installation and separation of the input unit 168 to the controller 110. The attachment/detachment recognition switch 169 may be configured to directly/indirectly contact the input unit 168 when the input unit 168 is mounted. Accordingly, the attachment/detachment recognition switch 169 may generate the signal corresponding to the installation or the separation of the input unit 168 (that is, signal informing of the installation or the separation of the input unit 168) and output the generated signal to the controller 110 based on whether the attachment/detachment recognition switch 169 contacts the input unit 168.

The sensor module 170 includes at least one sensor for detecting a state of the electronic device 100. For example, the sensor module 170 may include at least one of a proximity sensor for detecting whether the user approaches the electronic device 100, an illumination sensor for detecting an amount of ambient light of the electronic device 100, a motion sensor for detecting a motion (for example, rotation, acceleration, or vibration of the electronic device 100) of the electronic device 100, a geo-magnetic sensor for detecting a point of the compass by using the Earth's magnetic field, a gravity sensor for detecting a gravity action direction, an altimeter for measuring an atmospheric pressure to detect an altitude, and a GPS module 157.

The GPS module 157 may receive radio waves from a plurality of GPS satellites in Earth's orbit and calculate a position of the electronic device 100 by using Time of Arrival from the GPS satellites to the electronic device 100.

The storage unit 175 may store a signal or data input/output according to the operation of the communication module 120, the multimedia module 140, the camera module 150, the input/output module 160, the sensor module 170, or the touch screen 190. The storage unit 175 may store a control program and applications for controlling the electronic device 100 or the controller 110.

The term “storage unit” refers to a random data storage device such as the storage unit 175, the ROM 112 or the RAM 113 within the controller 110, or a memory card (for example, an SD card or a memory stick) installed in the electronic device 100. The storage unit 175 may include a non-volatile memory, a volatile memory, or a Hard Disk Drive (HDD) or a Solid State Drive (SSD).

Further, the storage unit 175 may store applications having various functions such as a navigation function, a video call function, a game function, and a time based alarm function, images for providing a Graphical User Interface (GUI) related to the applications, databases or data related to a method of processing user information, a document, and a touch input, background images (a menu screen, an idle screen or the like) or operating programs required for driving the electronic device 100, and images photographed by the camera module 150.

The storage unit 175 is a machine (for example, computer)-readable medium for providing data to the machine to perform a specific function. The storage unit 175 may include a non-volatile medium and a volatile medium. All of these media should be a type that allows the commands transferred by the media to be detected by a physical instrument in which the machine reads the commands into the physical instrument.

The computer readable storage medium includes, but is not limited to, at least one of a floppy disk, a flexible disk, a hard disks, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM, and an embedded Multi-Media Card (eMMC).

The power supply unit 180 may supply power to one battery or a plurality of batteries arranged at the housing of the electronic device 100. The battery or the plurality of batteries supply power to the electronic device 100. Further, the power supply unit 180 may supply power input from an external power source through a wired cable connected to the connector 165 to the electronic device 100. In addition, the power supply unit 180 may also supply power wirelessly input from the external power source through a wireless charging technology to the electronic device 100.

The electronic device 100 may include at least one touch screen 190 providing user graphical interfaces corresponding to various services (for example, a phone call, data transmission, broadcasting, and photography) to the user. The touch screen 190 may output an analog signal corresponding to at least one user input into the user graphical interface to the touch screen controller 195.

The touch screen 190 may receive at least one user input through a user's body (for example, fingers including a thumb) or the input unit 168 (for example, a stylus pen or an electronic pen). The touch screen 190 may be implemented in a resistive type, a capacitive type, an infrared type, an acoustic wave type, or a combination thereof.

Further, the touch screen 190 may include at least two touch panels which may detect touches or approaches of the finger and the input unit 168, respectively, in order to receive inputs of the finger and the input unit 168, respectively. The two or more touch panels provide different output values to the touch screen controller 195. Then, the touch screen controller 195 may recognize the different values input to the two or more touch panels to distinguish whether the input from the touch screen 190 is an input by the finger or an input by the input unit 168.

In addition, the touch is not limited to a touch between the touch screen 190 and the user's body or touchable input means, but includes a non-contact (for example, a case where an interval between the touch screen 190 and the user's body or touchable input means is 1 mm or shorter). The detectable interval of the touch screen 190 may be changed according to a capability or structure of the electronic device 100.

The touch screen controller 195 converts an analog signal received from the touch screen 190 to a digital signal and transmits the converted digital signal to the controller 110. The controller 110 may control the touch screen 190 by using the digital signal received from the touch screen controller 195. The touch screen controller 195 may identify a hovering interval or distance as well as a position of the user input by detecting a value (for example, a current value or the like) output through the touch screen 190, convert the identified distance value to a digital signal (for example, a Z coordinate), and then provide the converted digital signal to the controller 110. Further, the touch screen controller 190 may detect a pressure applied to the touch screen 190 by the user input unit by detecting the value (for example, the current value or the like) output through the touch screen 190, convert the identified pressure value to a digital signal, and then provide the converted digital signal to the controller 110.

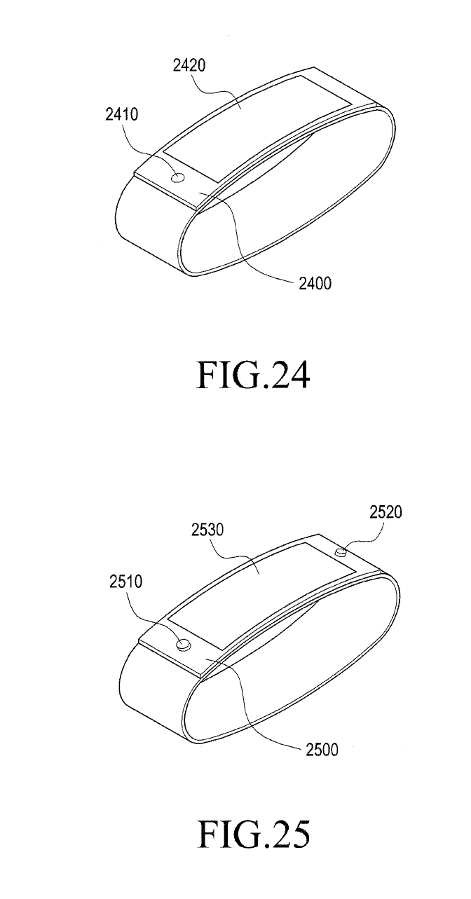

FIG. 23 illustrates an example of a wearable device according to an embodiment of the present disclosure.

The aforementioned watch type device according to the embodiment of the present disclosure is a type of wearable device and is a device that can be worn on the wrist similar to a general watch. The watch type device may include therein a central processing unit performing an operation, a display unit displaying information, a communication device associated with peripheral electronic devices, and the like. Further, the watch type device may be used as a camera for general photographing or recognition, by including therein a camera for photographing images.

Referring to FIG. 23, in a case where a first electronic device 100a corresponds to a watch type device as illustrated, the first electronic device 100a may include a storage unit, a controller, and an input/output device, which have smaller capacity and processing capability relative to a second electronic device 100b. For example, the watch type device may be a terminal having such a size that it can be worn on a user's body. The watch type device may be worn on a user's wrist, while being coupled to a hardware structure (e.g., a watchband) as illustrated.

Further, the watch type device as an input/output device may include a touch screen 181 having a predetermined size, and may also further include at least one hardware button 183.

Meanwhile, the watch type device may detect a signal generated by a user's gesture, analyze a waveform of the detected signal to identify the user's gesture, and perform a function corresponding to the identified user's gesture according to an embodiment of the present disclosure.

FIGS. 24 to 28 illustrate examples of a wearable device according to other embodiments of the present disclosure.

Referring to FIG. 24, a watch type device 2400 may include a sensor 2410 and a display unit 2420. For example, the watch type device 2400 may be a terminal having such a size that it can be worn on a user's body. The watch type device 2400 may be worn on a user's wrist while being coupled to a hardware structure (e.g., a watchband) as illustrated.

Meanwhile, the watch type device 2400 may detect a signal generated by a user's gesture through the sensor 2410 according to an embodiment of the present disclosure.

The sensor 2410 may detect an input by a sound in the air or a vibration of a medium.

Referring to FIG. 25, a watch type device 2500 may include a plurality of sensors 2510 and 2520, and a display unit 2530. For example, the watch type device 2500 may be a terminal having such a size that it can be worn on a user's body. The watch type device 2500 may be worn on a user's wrist while being coupled to a hardware structure (e.g., a watchband) as illustrated.

Meanwhile, the watch type device 2500 may detect a signal generated by a user's gesture through the plurality of sensors 2510 and 2520 according to an embodiment of the present disclosure.

Through the detection of the signal generated by the user's gesture, the plurality of sensors 2510 and 2520 may determine a location or various objects (e.g., a tempered glass 1900, a desk 1910, a keyboard 1920, a general noise 1930, and the like, without being limited thereto) on which the user's gesture has been generated and may identify whether the watch type device 2500 has been worn on the user's right or left hand.

Referring to FIG. 26, a watch type device 2600 may include a sensor 2610 that may contact a user's body part. For example, the watch type device 2600 may be a terminal having such a size that it can be worn on a user's body. The watch type device 2600 may be worn on a user's wrist, while being coupled to a hardware structure (e.g., a watchband) as illustrated.

Meanwhile, the watch type device 2600 may detect a signal generated by a user's gesture, by using the sensor 2610 disposed at the inside thereof to contact a user's body according to an embodiment of the present disclosure.

Referring to FIG. 27, a watch type device 2700 may include a plurality of sensors 2710 and 2720 that may contact a user's body part. For example, the watch type device 2700 may detect a signal generated by a user's gesture through the plurality of sensors 2710 and 2720 disposed at the inside thereof according to an embodiment of the present disclosure.

Through the detection of the signal generated by the user's gesture, the plurality of sensors 2710 and 2720 may determine a location or various objects (e.g., a tempered glass 1900, a desk 1910, a keyboard 1920, a general noise 1930, and the like, without being limited thereto) on which the user's gesture has been generated and may identify whether the watch type device 2700 has been worn on the user's right or left hand.

Referring to FIG. 28, a watch type device 2800 may include a plurality of sensors 2810 and 2820 that may contact a user's body part. For example, the watch type device 2800 may detect a signal generated by a user's gesture by using the plurality of sensors 2810 and 2820 disposed at the inside portion of a watchband according to an embodiment of the present disclosure. At this time, the plurality of sensors 2810 and 2820 may be disposed in a diagonal direction in the watch type device 2800 illustrated in FIG. 28. Accordingly, the watch type device 2800 may more effectively determine a direction of a sound and a vibration detected by the plurality of sensors 2810 and 2820 disposed in the diagonal direction according to the embodiment of the present disclosure.

Further, methods according to various embodiments of the present disclosure may be implemented in a type of a program command and stored in the storage unit 150 of the device 100, and the program command may be temporarily stored in the RAM 113 included in the controller 110 to execute the methods according to the various embodiments of the present disclosure. As a result, the controller 110 may perform a control of hardware components included in the device 100 in response to the program commands according to the methods of the various embodiments of the present disclosure, temporarily or continuously store data generated through execution of the methods according to the various embodiments in the storage unit 150, and provide UIs required for executing the methods according to the various embodiments of the present disclosure to the touch screen controller 172.

As described above, although the present disclosure has described the specific matters such as concrete components, the limited various embodiments, and the drawings, they are provided merely to assist general understanding of the present disclosure and the present disclosure is not limited to the various embodiments. Various modifications and changes can be made from the description by those skilled in the art.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of performing a function of an electronic device, the method comprising:
detecting a signal generated by a user gesture;
identifying the user gesture by analyzing a waveform of the detected signal; and
performing a function corresponding to the identified user gesture.

2. The method of claim 1, wherein the signal generated by the user gesture comprises a signal generated by a touch of the user.

3. The method of claim 2, wherein the signal generated by the touch of the user comprises a signal generated by a swipe of the user in a specific direction, and the swipe comprises a gesture performed on the user body in a horizontal or vertical direction by a predetermined distance while the user body is touched.

4. The method of claim 2, wherein the signal generated by the touch of the user comprises a signal generated by a tap of the user in a specific direction, and the tap comprises a gesture of shortly and lightly tapping a body of the user with a finger.

5. The method of claim 1, wherein the performing of the function corresponding to the identified user gesture comprises performing a function set in advance to correspond to a currently set mode.

6. The method of claim 5, wherein the currently set mode comprises at least one of a standby mode, a watch mode, a video mode, a music mode, a motion mode, a call mode, a photographing mode, and a short distance communication connecting mode.

7. The method of claim 1, further comprising:
detecting a location where the electronic device is being worn based on the signal generated by the user gesture.

8. The method of claim 1, wherein the identifying of the user gesture comprises:
detecting the signal generated by the user gesture through at least one sensor; and
identifying the user gesture based on the detected signal.

9. A non-transitory computer-readable storage medium configured to store instructions that, when executed, cause at least one processor to perform the method of claim 1.

10. A method of performing a function of an electronic device, the method comprising:
detecting a first signal generated by a first user gesture;
identifying a type of a second electronic device to be controlled based on a waveform of the first signal;
connecting the electronic device with the second electronic device through a communication unit; and
controlling the second electronic device.

11. The method of claim 10, wherein the controlling of the second electronic device comprises:
detecting a second signal generated by a second user gesture; and
controlling the second electronic device by identifying the second user gesture based on the second signal.

12. The method of claim 10, further comprising:
receiving a signal input by the second electronic device; and
displaying information based on the received signal.

13. The method of claim 10, wherein the communication unit comprises a short distance communication unit.

14. A non-transitory computer-readable storage medium configured to store instructions that, when executed, cause at least one processor to perform the method of claim 10.

15. An electronic device comprising:
a sensor configured to detect a signal generated by a user gesture; and
a controller configured to identify the user gesture by analyzing a waveform of the detected signal and control a function corresponding to the identified user gesture.

16. The electronic device of claim 15, wherein the signal generated by the user gesture comprises a signal generated by a touch of the user.

17. The electronic device of claim 16, wherein the signal generated by the touch of the user comprises a signal generated by a swipe in a specific direction and the swipe comprises a gesture performed on the user body in a horizontal or vertical direction by a predetermined distance while the user body is touched.

18. The electronic device of claim 16, wherein the signal generated by the touch of the user comprises a signal generated by a tap of the user in a specific direction and the tap comprises a gesture tapping a body of the user with a finger.

19. The electronic device of claim 16, wherein the function corresponding to the identified user gesture comprises a function set in advance to correspond to a currently set mode.

20. The electronic device of claim 19, wherein the currently set mode comprises at least one of a standby mode, a watch mode, a video mode, a music mode, a motion mode, a call mode, a photographing mode, and a short distance communication connecting mode.

21. The electronic device of claim 15, wherein the sensor is configured to detect a location where the electronic device is being worn based on the signal generated by the user gesture.

22. The electronic device of claim 15, wherein the controller further comprises at least one sensor that detects the signal generated by the user gesture and identifies the user's gesture based on the detected signal.

23. An electronic device comprising:
a communication unit;
a sensor configured to detect a first signal generated by a first user gesture; and
a controller configured to identify a type of a second electronic device to control based on a waveform of the first signal, to connect the electronic device with the second electronic device through the communication unit, and to control the second electronic device.

24. The electronic device of claim 23, wherein the controller is configured to detect a second signal generated by a second user gesture via the sensor and to control the second electronic device by identifying the second user gesture based on the second signal.

25. The electronic device of claim 23, further comprising:
a display unit configured to, when receiving a signal input by the second electronic device through the communication unit, display information based on the received signal.

26. The electronic device of claim 23, wherein the communication unit connects the electronic device with second electronic device through a short distance communication unit.
